(19) United States
(12) Patent Application Publication
(10) Pub. No.: US 2016/0331178 A1
(43) Pub. Date: Nov. 17, 2016

(54) Grill Caddy

(71) Applicant: Edward Michael Guzman, Long Beach, CA (US)

(72) Inventor: Edward Michael Guzman, Long Beach, CA (US)

(21) Appl. No.: 15/153,677

(22) Filed: May 12, 2016

Related U.S. Application Data
(60) Provisional application No. 62/161,138, filed on May 13, 2015.

(51) Int. Cl. A47J 37/07; A47B 13/08

(52) U.S. Cl. CPC A47J 37/0786; A47B 13/08

(57) ABSTRACT

The present invention relates to the field of culinary arts. Specifically, a food preparation table and adjustable carrier for outdoor grill supplies and utensils, consisting of recessed slot with a cutting board inset, hooks for holding kitchen/barbecue utensils, a pan, a kitchen towel holder, a bottle opener, a bowl, a magnet, a paper towel holder, and a basket.

### CROSS-REFERENCE RELATED APPLICATION

This application claims the benefit of U.S. application No. 62/161,138, filed 13 May 2015 which is incorporated herein by reference.

### FIELD AND BACKGROUND OF THE INVENTION

1. Field of the Invention

The field of the invention relates to the culinary arts, specifically food preparation utensils.

2. Background of the Invention

Outdoor cooking has been a popular entertainment and family diversion in the United States since the mid-1940s. Common events, such as family reunions, birthday parties and “tailgating” in stadium parking lots before sporting events, such as college and professional football games, utilize outdoor cooking. An industry has arisen to provide the outdoor cook with the accessories needed to successfully perform the outdoor cooking operation. While cooking outdoors has its advantages, such as the ability to prepare foods in a tasty manner and fostering a sense of community at outdoor parties, there are disadvantages, including the smoke and odors produced by outdoor cooking methods, such as cooking over hot coals or using a smoker. Cooking outdoors often requires the chef to transit back and forth between the outdoor grill and an indoor kitchen; for an average person, this is a mere inconvenience, for individuals with disabilities, this can be prohibitive; While permanent outdoor food preparation structures may be built, these can be prohibitively expensive for the average consumer. Furthermore, food preparation on commonly available surfaces, such as picnic tables, are unsanitary and carry a risk of transmitting foodborne illnesses.

Therefore there exists a need for an invention which allows for the ease of preparation of food in an outdoor environment.

### SUMMARY OF THE INVENTION

The exemplary embodiment of the present invention addresses a need to aid in the outdoor preparation of food, which allows convenient and sanitary access to individuals to prepare food in an outdoor setting. The invention consists of a table used as a caddy to hold barbecue supplies and utensils. The table was designed to allow the user to utilize the proper equipment/utensils while cooking/barbecuing. The user can chop on the cutting board provided and slide food directly into a mixing bowl for later use. Features included in the table include: a height adjustable leg; a rack/hook to hold utensils; a basin for raw or cooked food; a bottle opener; a bowl; a holder for kitchen towels; a garment or utility hook; a magnet for knives or metal utensils; a paper towel holder and a basket for holding spices and or condiments.

### BRIEF DESCRIPTION OF THE DRAWINGS

These and other objects, features, and aspects of the invention will be better understood and more fully described upon reading the following detailed description in conjunction with the appended drawings wherein:

FIG. 1 is a perspective view of the invention, a utensil for preparing food at an outdoor grill.

FIG. 2 is a photograph of the underside of the invention.

### DETAILED DESCRIPTION

Certain embodiments as disclosed herein provide for a food preparation table and adjustable carrier for outdoor grill supplies and utensils. After reading this description it will become apparent to one skilled in the art how to implement the invention in various alternative embodiments and alternative applications. Although various embodiments of the present invention will be described herein, it is understood that these embodiments are presented by way of example only, and not limitation. As such, this detailed description of various alternative embodiments should not be construed to limit the scope or breadth of the present invention.

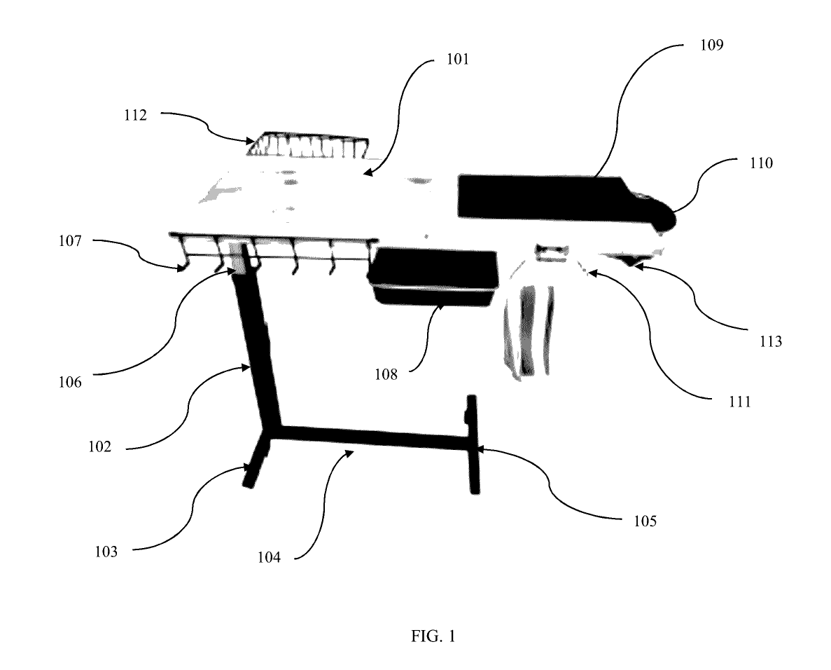

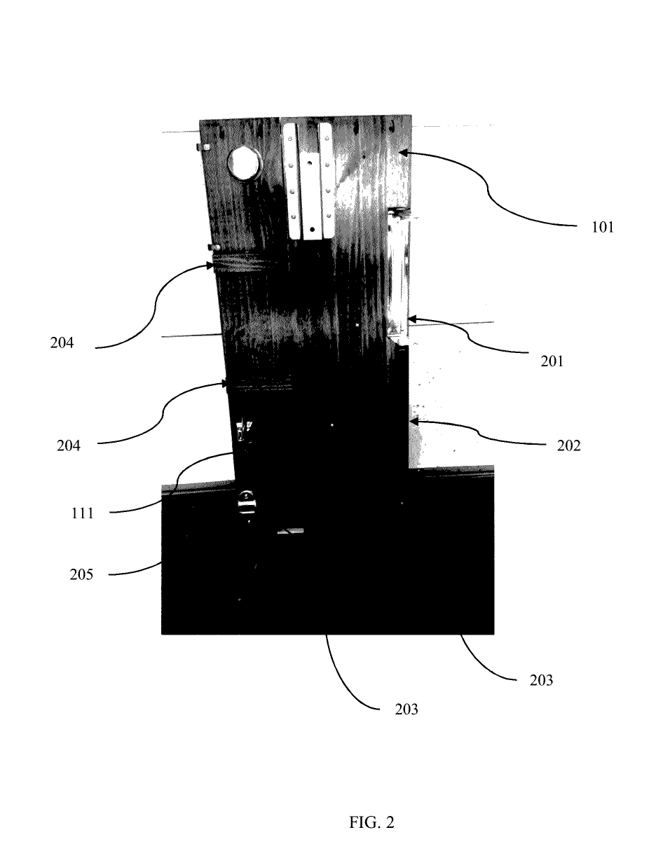

Referring now to FIGS. 1 and 2, which detail a preferred embodiment of the invention. The invention consists of a table 101 supported by a height adjustable vertical leg 102, which is in turn supported by at least three horizontal supports 103,104, 105. The table 101 includes several built-in items, including: a basket 112 for holding spices and/or condiments, a rack/hooks 107 to hold utensils, pan 108, cutting board 109, paper towel holder 201, a magnet 202 for knives or metal utensils, D ring wall mount metal towel holder 111, a bottle opener 2013 and bowl 110.

The table 101 is used as a caddy to hold barbecue supplies and utensils. The table 101 is designed to allow the user to utilize an ease of use for equipment/utensils while cooking/barbecuing. In the preferred embodiment, the tabletop surface dimensions are 18″ width×38″ length×1.125″ thick and constructed of laminated pine and Hard Rock Maple. The table 101 offers 4.5 ft² of prep space, it allows the user to put buns, bread, plates or anything else a person ordinarily uses during the grill session. There is a recessed area on the top surface of the table to allow an 8×11 to 10×14 inch cutting board to be recessed and flush with the surface. The cutting board 109, made of wood, plastic, metal, and/or polycarbonate, allows the user to cut meat, fish, poultry etc. on the table. The user can chop on the cutting board provided and slide food directly into a bowl 110 for later use.

On either side of the table 101, are metal brackets used to hold a removable spice basket 112. This basket 112 is designed to hold spices used for seasoning meat or condiments such as ketchup and mustard. The basket 112 is removable so that the user can fill it up with all the spices/condiments that they will need at a kitchen or other remote and/or remote location and set it on table-side mounted brackets keeping the tabletop free and open for other items.

A first set of rails 203 are attached under the table and to hold a 2 quart or 3 quart mixing bowl 110 that the bowl can either be stowed under the table or slide out for food to be slid/pushed directly from the cutting surface into the mixing bowl. The runners 203 may be constructed of wood, metal or plastic.

The paper towel holder 201 features built-in spring tension to hold paper towels securely to the table and allows the user to have paper towels at their disposal. It is fastened on the underside of the table normally next to the spice basket.

Utility hooks 107 installed on the back underside of the table so the user can hang grill utensils such as tongs, forks, grill brush etc. This allows the user to keep all the necessary tools exactly where they are being used.

A metal magnet 202 is positioned under the table along the long-side, underside of the table, so that the user can cut or chop on the cutting board and then quickly secure the knife to the magnet, keeping the tabletop free of dangerous sharp objects and removing the chance of the knife being knocked off the table and injuring someone's foot.

Positioned behind the bottle opener 205, is a D ring wall mount metal towel holder 111, designed to allow the user to have a kitchen towel on hand for various uses.

Positioned next to the towel holder 201, under the table, is a second set of runners 204 designed to hold a metal basin for food (steam table pans, baking pans). The second set of runners 204 are placed to support a pan 108. The runners 204 may be constructed of wood, metal or plastic. The pan 108 may be used for various functions such as marinating meat, transferring food from the kitchen, storing food under the table and keeping it warm until it's time to take it inside.

Next to the runners 203, is a wall mount bottle opener 205. This is in place for user convenience, so that one has the ability to open beverages at the grill site and reduces trips to the kitchen or bring an extra utensil, which may be lost.

Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

I claim:

1. A food preparation table and carrier for outdoor grilling supplies used for cutting, preparing, handling, and containing various foods, comprising: a table, a basin for food, a kitchen towel holder, a bottle opener, a mixing bowl, a garment hook, a magnet, a paper towel holder, a basket, a rack of four to six hooks, a cutting board; wherein said table is rectangular in shape, has a top side and an underside; wherein the underside of said table is attached to a height adjustable vertical support; wherein said vertical support is connected to a horizontal support parallel to the table surface; wherein said magnet is positioned on the underside of said table; wherein said basin for food is held in place by two runners located along a long side, on the underside of said table; wherein said mixing bowl is held in place by two runners located along a short side, on the underside of said table; wherein said rack of four to six hooks is located on a side of said table, along a long side; wherein said bottle opener is attached to the underside of said table.

2. The food preparation table of claim 1, wherein said food preparation table and carrier is constructed of laminated pine and hard rock maple.

3. The food preparation table of claim 1, wherein the top surface of said food preparation table surface has a flat end and a routed end; wherein said cutting board fits inside said routed end, so that when said cutting board is in said routed end, said cutting board is flush with said table top surface.
